(19) United States
(12) Patent Application Publication
(10) Pub. No.: US 2007/0193937 A1
(43) Pub. Date: Aug. 23, 2007

(54) Modified substrate for removing aqueous oxyanions

(76) Inventor: Fouad R. Hagseresht, Toowong (AU)

Correspondence Address: Matthew R Osenga;Williams Mullen, PO Box 1320, 1021 E Cary Street, Richmond, VA, 23218-1320, US

(21) Appl. No.: 10/592,173

(22) PCT Filed: Mar. 9, 2005
(86) PCT No.: PCT/AU05/00332

§ 371 Date: Sep. 8, 2006

(30) Foreign Application Priority Data
Mar. 10, 2004 (AU) 2004901229
Mar. 30, 2004 (CN) 200410035210.0

(51) Int. Cl. B01D 15/00

(52) U.S. Cl. 210/263

(57) ABSTRACT

A modified substrate for removing aqueous oxyanions formed by: selecting a substrate from minerals or mineral equivalents having a naturally moderate to high cation exchange capacity; forming a substrate modifier from salts of the Group IIIB and Group IVB elements by dissolving one or more of the salts in water at an elevated temperature; and blending the substrate with the substrate modifier at a high shear rate.

### FIELD OF INVENTION

THIS INVENTION relates to an improved modified substrate for removing aqueous oxyanions. The invention has particular application to removing phosphates from water and/or marine or submerged soils, but is not limited to such use.

### BACKGROUND ART

The removal of oxyanions and/or phosphorus using a doped substrate is described in International Patent Application No. PCT/AU97/00892 by the Commonwealth Scientific and Industrial Research Organisation, the specification of which is incorporated herein by reference (“the CSIRO technology”). The CSIRO technology relates to a remediation material and a redmediation process for sediments.

It has been discovered that by selection of appropriate parameters, components and/or formulation criteria, improved results may be obtained.

The present invention aims to provide a substrate which has improved capabilities for removing aqueous oxyanions over the prior art. Another aim of the invention is to provide solid substrate material having rapid dispersion characteristics in water. Another aim is to provide a liquid substrate material which is more economical to prepare than slurries of the prior art. Other aims and advantages of the invention may become apparent from the following description.

### DISCLOSURE OF THE INVENTION

With the foregoing in view, this invention resides broadly in a modified substrate for removing aqueous oxyanions formed by:

selecting a substrate from minerals or mineral equivalents having a naturally moderate to high cation exchange capacity;

forming a substrate modifier from salts of the Group IIIB and Group IVB elements by dissolving one or more of the salts in water at an elevated temperature; and

blending the substrate with the substrate modifier at a high shear rate.

The term modified when used in the context of the modified substrate of the present invention includes, but is not limited to such mechanisms and/or processes as doping, cation exchange, sorption of a complexing element, or combinations thereof. Oxyanions for removal principally include phosphates, but also include arsenate, vanadate, chromate, selenate, tungstate, niobate, tantalate and tellurate amongst others, peroxyanions such as persulphate and the like.

In another aspect, the present invention resides broadly in a granulated modified substrate for removing aqueous oxyanions, the granulated modified substrate formed by:

selecting a substrate from minerals or mineral equivalents having a naturally moderate to high cation exchange capacity;

forming a substrate modifier from salts of the Group IIIB and Group IVB elements by dissolving one or more of the salts in water at an elevated temperature;

blending the substrate with the substrate modifier at a high shear rate to form a modified substrate; and

granulating the modified substrate so modified being formed into granules for dispersion into water.

The granulation of the substrate may be carried out by a granulation process drying, preferably with wetting and/or dispersing agents, in accordance with known granulation techniques. Moreover, the drying may include processes or unit operations to remove such water or diluent as may be removed with relative ease. One preferred method of granulation includes, for example, settling to form a sludge of modified substrate below a supernatent liquid, extrusion of the sludge, granulation of the extruded sludge to form granules, and drying of the granules. Preferably, the temperature of the water is in the range of 40° and 80° C. for the mixing of the substrate therein. It is also preferred that the mixing conditions include mixing with a high shear disperser operable in range of 1,500 to 7,000 rpm.

It is preferred that the dewatered slurry be formulated as follows:

(a) Morwett D425 in the range of 3% to 7%;

(b) be selected from any form of precipitated or fumed silica, for example, Hisil 257 in the range of from 3% to 7%;

(c) moisture of from 3% to 5%; and

(d) Phoslock in the range of from 81% to 91%.

It will be appreciated that the Phoslock described herein relates to the material formed and described in respect of the CSIRO technology.

In another aspect, the present invention resides broadly in a method of removing at least some of the aqueous oxyanions from water containing aqueous oxyanions, the method including:

providing a substrate selected from minerals or mineral equivalents having a naturally moderate to high cation exchange capacity;

dissolving one or more salts of the Group IIIB and Group IVB elements in water at an elevated temperature to form a substrate modifier;

blending the substrate with the substrate modifier at a high shear rate to form a modified substrate; and

adding the modified substrate to the water containing the oxyanions in an amount sufficient to substantially bind at least some of the oxyanions.

The binding of oxyanions renders them unavailable to the water to which the substrate is added by precipitation, sequestration, or similar chemical processes. In the case where the modified substrate is added to a sill body of water, such as a lake, the modified substrate bonds to oxyanions and precipitates to fall to the bottom of the body of water and may intermingle and/or interact with the mud or soil thereat. The modified substrate may be added to an aqueous process stream containing one or more oxyanions, the precipitated or coalesced material being then separated from the water.

The Group IIIB and IVB elements will be understood to be those set forth in the periodic table of the elements as defined by the International Union of Pure and Applied Chemistry (IUPAC).

In another aspect, the present invention resides broadly in a method of forming a substrate for removing oxyanions including the steps of:

mixing minerals or mineral equivalents having a naturally moderate to high cation exchange capacity with an aqueous diluent in a primary mixing tank at a temperature in the range of 40° C. and 80° C. and at a high shear rate for a time sufficient to form a slurry;

passing the slurry into a secondary mixing and holding tank having a capacity at least sufficient to accommodate variations in supply of the slurry thereto from the primary mixing tank;

centrifuging the slurry from the secondary mixing tank into supernatant liquid and a concentrated slurry;

filtering the supernatant through a filtering medium into a filtrate and concentrate;

returning the filtrate to the primary tank as diluent;

extruding the concentrate from the centrifuge into an extruded concentrate and an expelled liquid;

returning the expelled liquid to the primary tank through the filtering medium;

granulating the concentrate received from the extruder to form a granulated substrate and a released liquid;

returning the released liquid to the primary tank through the filtering medium; and

drying the granulated substrate to produce a finished product.

The finished product may be packaged in bulk or in retail-type packages as required by end users. The finished product according to the invention is believed to possess superior dispersing characteristics to enable addition to water in order to effect oxyanion removal in a more convenient manner compared with the prior art. The finished product according to the invention may, for example, be used in remediation of soils as described in the CSIRO Technology.

In another aspect, the present invention resides broadly in apparatus for formulating a modified substrate for removing aqueous oxyanions including:

a primary mixing tank for mixing minerals or mineral equivalents having a naturally moderate to high cation exchange capacity with an aqueous diluent at a temperature in the range of 40° C. and 80° C. and at a high shear rate for a time sufficient to form a slurry;

a secondary mixing and holding tank having a capacity at least sufficient to accommodate variations in supply of the slurry thereto in fluid connection with the primary mixing tank;

a centrifuge in fluid connection with the secondary mixing and holding tank for receiving the slurry for centrifugation into a supernatant liquid and a concentrated slurry, the centrifuge being in fluid connection with the a filter;

an extruder in operative connection with the centrifuge for receiving the concentrated slurry therefrom and in fluid connection with the filter;

a granulator in operative connection with the extruder for receiving extruded concentrate therefrom and in fluid connection with the filter for passing released liquid from the granulator thereto;

a drier in operative connection with the granulator for drying granulated substrate received therefrom, the filter having an operative connection to the primary tank for recycling filtrate thereto as diluent.

### BRIEF DESCRIPTION OF THE DRAWINGS

In order that the invention may be more readily understood and put into practical effect, reference will now be made to the accompanying drawings which illustrate a preferred embodiment of the invention and wherein:

FIG. 1 is a process flowchart describing a preferred process according to the invention.

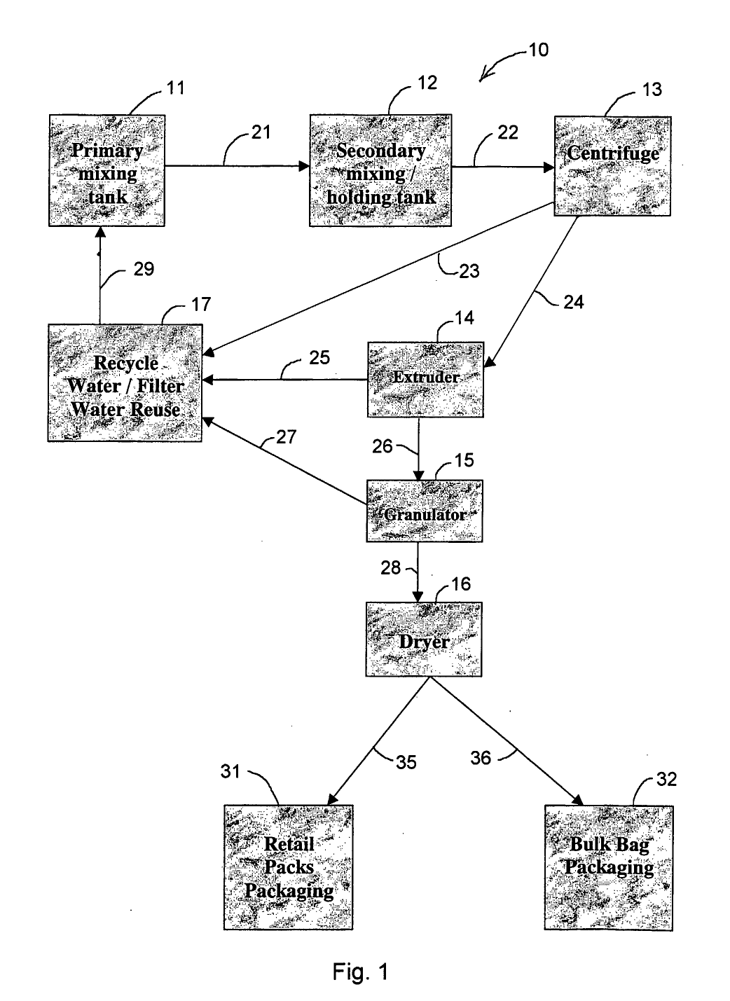

### DETAILED DESCRIPTION OF THE DRAWINGS

The process 10 shown includes a primary tank 11 in fluid connection with a secondary mixing and holding tank 12 by way of a primary slurry line 21. The secondary mixing holding tank in fluid connection with a centrifuge 13 by way of a secondary slurry line 22. The centrifuge is in operative connection to an extruder 14 by way of a concentrated slurry line 24, and in operative connection with a recycle filter 17 by way of a supernatant line 23. The extruder is also in fluid connection with the recycle filter by way of an expelled liquid line 25, as well as being in operative connection to a granulator 15 by way of an extruded concentrate line 26. The granulator is in liquid connection with the recycle filter by way of a release liquid line 27, and in operative connection with a dryer 16 by way of a granulated feed line 28. The dryer is in operative connection with either or both a retail packaging process 31 by way of a first dried product line 35 and/or a bulk packaging process 32 by way of an alternative dry product line 36.

### EXAMPLES

In order that the invention may be more readily understood and put into practical effect, reference will now be made to the following examples which illustrate the prior art and an improved modified substrate according to the invention.

### EXAMPLE1

In order to provide a substrate according to the prior art, lanthanum chloride solution was prepared at 33.75 grams per liter by adding the appropriate amount of lanthanum salt to the suitable volume of water, while blending with a blender operated at about 1,000 to 1,400 rpm. Once all of the lanthanum chloride salt was dissolved, the required quantity of bentonite (250 grams per liter) was then added to the lanthanum chloride solution. The mixture was then blended for a further 4 to 6 hours. The resulting slurry was able to remediate estuarine and freshwater systems by removal of at least some of the oxyanions therein.

### EXAMPLE2

The mixture produced by the method of Example 1 was modified By using heated water (and maintaining the appropriate temperature throughout the mixing process) for the preparation of the slurry. Not only was lanthanum chloride dissolved in a shorter time, but also the manufacturing time of the slurry was also reduced significantly. In the modified method, the mixing was carried out by heating the water from 50° to 70° C. adding the required quantity of lanthanum chloride as described Example 1. Upon the dissolving of the lanthanum chloride, bentonite was added as described, but mixed at a high shear rate.

It seems that by using a high shear mixer, the particle size in the slurry can be predetermined. Accordingly, manufacturing process of the slurry can be manipulated to optimize the slurry for granulation. It is believed that the high shear mixing also provides better mixing of the slurry.

### EXAMPLE 3

The slurry formed in Example 2 was made in to granules by dewatering the slurry and mixing with two additives. The first is surfactant and the second of precipitated silica. It is believed that the additives assist in the dispersion of the granules into their original particle size as they descend through the water column after the application.

In addition to the more economical manufacturing process of the substrate of the present invention, it is believed that a greater oxyanion removal capacity per unit weight of active component can be achieved.

Although the invention has been described with reference to one or more specific examples, it will be appreciated by persons skilled in the art that the invention may be embodied in other forms which are encompassed within the broad scope and ambit of the invention as herein set forth.

1-2. (canceled)

3. A granulated modified substrate for removing aqueous oxyanions, the granulated modified substrate formed by:
selecting a substrate from minerals or mineral equivalents having a naturally moderate to high cation exchange capacity;
forming a substrate modifier from salts of the Group IIIB and Group IVB elements by dissolving one or more of the salts in water at an elevated temperature;
blending the substrate with the substrate modifier at a high shear rate to form a modified substrate; and
granulating the modified substrate so modified being formed into granules for dispersion into water.

4. A modified substrate according to claim 3, wherein the mixing conditions include mixing with a high shear disperser operable in the range of 1,500 to 7,000 rpm.

5. (canceled)

6. A method of forming a substrate for removing oxyanions including the steps of:
mixing minerals or mineral equivalents having a naturally moderate to high cation exchange capacity with an aqueous diluent in a primary mixing tank at a temperature in the range of 40° C. and 80° C. and at a high shear rate for a time sufficient to form a slurry;
passing the slurry into a secondary mixing and holding tank having a capacity at least sufficient to accommodate variations in supply of the slurry thereto from the primary mixing tank;
centrifuging the slurry from the secondary mixing tank into supernatant liquid and concentrated slurry;
filtering the supernatant through a filtering medium into a filtrate and concentrate;
returning the filtrate to the primary tank as diluent;
extruding the concentrate from the centrifuge into an extruded concentrate and an expelled liquid;
returning the expelled liquid to the primary tank through the filtering medium;
granulating the concentrate received from the extruder to form a granulated substrate and a released liquid;
returning the released liquid to the primary tank through the filtering medium; and
drying the granulated substrate to produce a finished product.

7. Apparatus for formulating a modified substrate for removing aqueous oxyanions including:
a primary mixing tank for mixing minerals or mineral equivalents having a naturally moderate to high cation exchange capacity with an aqueous diluent at a temperature in the range of 40° C. and 80° C. and at a high shear rate for a time sufficient to form a slurry;
a secondary mixing and holding tank having a capacity at least sufficient to accommodate variations in supply of the slurry thereto in fluid connection with the primary mixing tank;
a centrifuge in fluid connection with the secondary mixing and holding tank for receiving the slurry for centrifugation into a supernatant liquid and a concentrated slurry, the centrifuge being in fluid connection with a filter;
an extruder in operative connection with the centrifuge for receiving the concentrated slurry therefrom and in fluid connection with the filter;
a granulator in operative connection with the extruder for receiving extruded concentrate therefrom and in fluid connection with the filter for passing released liquid from the granulator thereto; and
a drier in operative connection with the granulator for drying granulated substrate received therefrom, the filter having an operative connection to the primary tank for recycling filtrate thereto as diluent.

8-9. (canceled)
